(19) United States
(12) Patent Application Publication
(10) Pub. No.: US 2023/0217984 A1
(43) Pub. Date: Jul. 13, 2023

(54) AN ON-SITE COFFEE ROASTING SYSTEM AND METHOD THEREOF

(71) Applicant: GRIIN ROASTING LTD, Ramat Gan (IL)

(72) Inventors: Yuval WEISGLASS, Gan Haim (IL); Matan SCHARF, Giv'atayim (US); Jonathan SCHARF, Ramat Gan (IL)

(21) Appl. No.: 17/913,239

(22) PCT Filed: Mar. 25, 2021
(86) PCT No.: PCT/IL2021/050343

§ 371 Date: Sep. 21, 2022

Related U.S. Application Data
(60) Provisional application No. 62/994,300, filed on Mar. 25, 2020.

(51) Int. Cl. A23N 12/12; A47J 31/42; A47J 42/52; A23F 5/04; H05B 6/68; H05B 6/74

(52) U.S. Cl. CPC A23N 12/125; A47J 31/42; A47J 42/52; A23F 5/04; H05B 6/687; H05B 6/745; H05B 6/72

(57) ABSTRACT

It is the object of the present invention to present a coffee roaster, comprising: a resonant cavity, a heating unit, comprising: (i) at least one microwave oscillator and (ii) at least one beam-steerer, a sensing unit; and a control unit configured to control the microwave oscillator and the bean-steerer and receive data from the sensing unit.

### FIELD OF THE INVENTION

The invention is in the field of on-site coffee bean roasting and brewing.

### BACKGROUND OF THE INVENTION

Systems for the roasting of small batches of beans, at home, have been attempted. US2004/0000239 disclosed an apparatus for the roasting of small quantities of coffee beans in a vertically aligned, cylindrical roasting chamber, in which the unroasted coffee beans are charged batchwise. The roasting is effected by means of hot air flow through the roasting chamber. U.S. Pat. No. 5,749,288 describes a coffee bean roaster for home use in which a fan heater assembly that blows hot air upwardly through a glass roasting chamber. U.S. Pat. No. 6,053,093 described a device includes a housing, coffee bean roasting basket, chaff collector, heater and fan to conduct the roasting operation. The device also includes thermosensors that are located within the roasting basket whose output is provided to a microprocessor which, in turn, controls the roasting process by controlling roasting parameters.

US2018/0000108A1 discloses the systems and methods for brewing coffee, including providing an integrated beverage system that can include a grinding system, a roasting system, and a brewing system, and can roast, grind, and brew coffee.

U.S. Pat. No. 4,780,586 disclosed coffee roasting by the application of microwaves, regulated by a system free from any energy source which receives material from a microwave roaster and retains it for a time for completing roasting and varying and regulating the final degree of roasting of the material by regulating the feed of the roasted material from the system to a quenching zone. The microwave roaster includes a horizontal rotatable tube which has baffles for transporting the material to be roasted through the tube such that it reaches a roasting temperature at the outlet of the tube for receipt by the system for achieving the desired degree of final roasting.

U.S. Pat. No. 4,326,114 discloses a microwave oven that is incorporated in a coffee bean roasting system and includes a rotatable microwave transparent tube or drum positioned within the same and at an angle to the horizontal, through which coffee beans are introduced at an upper end and flow in continuous agitation to the lower end while being subjected to microwave fields within the oven. At the lower end of the oven a separate section is preferably provided for subjecting the coffee beans to selective treatment during the final stages of the roasting process. The oven feeds into a cooling and quenching chamber unit, to rapidly reduce the beans temperature.

U.S. Pat. No. 7,235,764 discloses a device and process to roast green coffee beans using a combination of microwave, conduction, convection, infrared, and latent steam heating. The device is a sealed cartridge that is semi porous and is used in a conventional or purpose-built microwave oven.

U.S. Pat. No. 10,412,988 discloses an apparatus for roasting coffee beans comprises a roasting chamber for containing coffee beans. The roasting chamber is positioned within a resonant cavity of a waveguide. A microwave emitter produces microwave energy within the waveguide with one or more stable high intensity microwave regions within the roasting chamber to heat the coffee beans in the roasting chamber to a temperature sufficient to roast the coffee beans. A device configured to move the coffee beans within the one or more high intensity microwave regions is coupled to the roasting chamber.

Korean application WO2019098506 discloses a method for controlling the roasting of coffee using microwave heating, the method being characterized in that roasting is completed in a coffee roasting device by: using raw coffee bean physical property data, pre-stored in a microcomputer or PLC, and coffee roasting operation information, input through an input unit, to calculate a roasting time (roasting retention time), an external air flow (hot air) temperature, and an appropriate microwave output corresponding to the temperature to achieve the target roasting step; and continuously operating a magnetron to input microwave energy. The continuous coffee roasting device using microwave heating comprises a microwave generation device intended to be used as a main heat source for roasting raw coffee beans and a microwave output control unit capable of controlling the microwave output of the microwave generation device, a hot air system providing an external air flow around the raw beans as hot air to prevent a cooling effect from occurring due to the external air when heating the raw beans with microwaves is installed, a transfer device continuously supplying the raw coffee beans and inducing the discharge of the coffee beans following roasting is provided, a shielding device for preventing microwaves from leaking out through open portions as the inlet and outlet portions of the roasting chamber (heating chamber and resonant cavity) must be open due to the raw coffee beans continuously entering and exiting the roasting chamber is installed, and a roasting device operation unit capable of controlling the overall operation of the continuous microwave roasting device is included.

Existing roasting methods incorporate poor monitoring and control technologies which require human control, involve heating methods that produce unwanted outputs (such as smoke, toxic materials, emission of heat, etc.) while being not efficient in energy delivery. The above makes it impossible to conduct roasting in non-industrial settings and prevent proper incorporation of roasting into coffee machines.

There exists a long-felt need for a system for the roasting of coffee at home and in other non-industrial spaces.

### SUMMARY

It is the object of the present invention to present a coffee roaster 100, comprising:
a. a resonant cavity 11;
b. a heating unit (HU) 13, comprising:
   a. at least one microwave oscillator;
      b. at least one beam-steerer;
c. a sensing unit (SU) 14; and
d. a control unit (CU) 15;

wherein the control unit is configured to control the microwave oscillator and the bean-steerer and receive data from the sensing unit.

It is another object of the present invention to provide the coffee roaster as presented any of the above, wherein the microwave oscillator is characterized as a phase locked generator, a magnetron or as solid-state.

It is another object of the present invention to provide the coffee roaster as presented any of the above, wherein the power state and power output of the microwave oscillator controlled by the CU.

It is another object of the present invention to provide the coffee roaster as presented any of the above, wherein the beam-steerer is configured to change the standing wave appearance.

It is another object of the present invention to provide the coffee roaster as presented any of the above, wherein the change in the wave appearance is characterized by at least one of the following:
a. wave path;
b. wave phase;
c. wave frequency.

It is another object of the present invention to provide the coffee roaster as presented any of the above, wherein the beam-steerer is characterized as a deflector.

It is another object of the present invention to provide the coffee roaster as presented any of the above, wherein the deflector is motorized.

It is another object of the present invention to provide the coffee roaster as presented any of the above, wherein the deflector is controlled by the CU.

It is another object of the present invention to provide the coffee roaster as presented any of the above, wherein the deflector is constructed by a food grade metal.

It is another object of the present invention to provide the coffee roaster as presented any of the above, additionally comprising at least one antenna, connected to the microwave oscillator.

It is another object of the present invention to provide the coffee roaster as presented any of the above, additionally comprising at least one waveguide, connected to the microwave oscillator.

It is another object of the present invention to provide the coffee roaster as presented any of the above, wherein the sensing unit is configured to detect at least one parameter, selected from a group consisting of:
a. bean temperature;
b. radiated heat within the cavity;
c. ambient temperature within the cavity;
d. Volatile Organic Compounds (VOCs) emissions;
e. bean color;
f. bean size;
g. bean shape;
h. sound;
i. the amount of energy absorbed by the beans;
j. the amount of energy not absorbed by the beans; and
k. the amount of energy returned to the heat source.

It is another object of the present invention to provide the coffee roaster as presented any of the above, wherein the sensing unit comprises at least one detection system selected from a group consisting of thermal imaging, fiber optic based thermal sensing, image sensor, camera, spectroscopic sensor, microphone, chemical detector and microwave receiver.

It is another object of the present invention to provide the coffee roaster as presented any of the above, wherein the spectroscopic sensor is selected from a group consisting of Infra-red and Ultraviolet based technologies.

It is another object of the present invention to provide the coffee roaster as presented any of the above, wherein the microphone is configured to detect a sound produced by the beans during roasting.

It is another object of the present invention to provide the coffee roaster as presented any of the above, wherein the control unit is configured to receive data from the sensing unit and regulate the heating unit.

It is another object of the present invention to provide the coffee roaster as presented any of the above, wherein the CU is configured to generate at least one HU order, the orders selected from a group consisting of brewing recipes and roasting profiles.

It is another object of the present invention to provide the coffee roaster as presented any of the above, wherein the CU is configured to generate at least one HU order, the order comprises at least one target point.

It is another object of the present invention to provide the coffee roaster as presented any of the above, wherein the target point is selected from a group consisting of bean temperature, cavity temperature, bean color, energy generated, energy absorbed, bean shape, bean sound, wave position, wave energy, wave power, antenna position, wave phase and VOC emissions.

It is another object of the present invention to provide the coffee roaster as presented any of the above, wherein the roasting unit comprises a container for holding the coffee beans.

It is another object of the present invention to provide the coffee roaster as presented any of the above, additionally comprising a container configured to hold unroasted coffee beans.

It is another object of the present invention to provide the coffee roaster as presented any of the above, wherein the beans are characterized as whole and un-grinded, partially grinded, completely grinded, characterized as a powder or any combination thereof. It is another object of the present invention to provide the coffee roaster as presented any of the above, wherein the container is configured to conduct at least one of the following:
a. receive the beans;
b. stir the beans;
c. mix the beans;
d. position the coffee beans;
e. remove the beans from the chamber;

It is another object of the present invention to provide the coffee roaster as presented any of the above, wherein the container is constructed from a food grade material, selected from a group consisting of Polyether ether ketone (PEEK) and Polytetrafluoroethylene (PTFE).

It is another object of the present invention to provide the coffee roaster as presented any of the above, additionally comprises a system for generating a flow of air.

It is another object of the present invention to provide the coffee roaster as presented any of the above, wherein the air is of the temperature range of −10° c to +300°.

It is another object of the present invention to provide the coffee roaster as presented any of the above, wherein the system is configured to:
a. be attached to an existing or external system, grinder, coffee brewer or container;
b. feed roasted beans to an external system, grinder, coffee brewer or container.

It is the object of the present invention to a method for the roasting of coffee beans, comprising steps of:
a. placing unroasted coffee beans in a chamber;
b. generating a roasting recipe;
c. generating an electromagnetic wave, the wave heating the beans in the chamber; and
d. measuring roasting parameters, the parameters selected from bean parameters and chamber parameters.

It is another object of the present invention to provide a method for the roasting of coffee beans as presented any of the above, additionally comprising a step of grinding the unroasted coffee beans.

It is another object of the present invention to provide a method for the roasting of coffee beans as presented any of the above, wherein the beans are placed in a container, configured to hold the beans.

It is another object of the present invention to provide a method for the roasting of coffee beans as presented any of the above, additionally comprising a step of changing the electromagnetic wave appearance.

It is another object of the present invention to provide a method for the roasting of coffee beans as presented any of the above, wherein the electromagnetic wave appearance is controlled by regulating at least one of the following:
a. power state of microwave generator;
b. power output of microwave generator;
c. wave path of microwave oscillator;
d. phase shift of microwave oscillator;
e. antenna array of microwave oscillator;

It is another object of the present invention to provide a method for the roasting of coffee beans as presented any of the above, wherein the electromagnetic wave appearance is characterized by at least one of the following:
a. homogenous radiating of the target beans;
b. homogenous radiating of the cavity;
c. rapid radiating of the target beans;
d. high energy efficiency.

It is another object of the present invention to provide a method for the roasting of coffee beans as presented any of the above, wherein the step of measuring roasting parameters comprises a parameter selected from a group consisting of bean temperature, radiated heat within the cavity, ambient temperature within the cavity, Volatile Organic Compounds (VOCs) emissions, bean color, sound generated by the beans, energy absorbed by the beans, energy not absorbed by the beans, and energy returned to the heat source.

It is another object of the present invention to provide a method for the roasting of coffee beans as presented any of the above, additionally comprising a step of generating at least one heating order.

It is another object of the present invention to provide a method for the roasting of coffee beans as presented any of the above, wherein the heating order is generated by a control unit.

It is another object of the present invention to provide a method for the roasting of coffee beans as presented any of the above, wherein the control unit is configured to conduct at least one of the following:
a. receive and read the measured parameters;
b. control the electromagnetic wave appearance;

It is another object of the present invention to provide a method for the roasting of coffee beans as presented any of the above, wherein the heating order is selected from a group consisting of bean temperature, cavity temperature, bean color, energy generated, energy absorbed bean sound, wave position, wave energy, wave power, antenna position, wave phase and VOC emissions.

It is another object of the present invention to provide a method for the roasting of coffee beans as presented any of the above, additionally comprising a step of loading coffee bean data.

It is the object of the present invention to provide a method for the brewing of a personalized cup of coffee, comprising:
a. selecting parameters for the cup of coffee;
b. measuring an amount of unroasted coffee beans;
c. roasting the unroasted coffee beans;
d. grinding the roasted coffee beans; and
e. brewing the cup of coffee;

wherein the coffee beans are roasted according to the method of any of the above.

It is the object of the present invention to provide a method for the brewing of a personalized cup of coffee, comprising:
a. selecting parameters for the cup of coffee;
b. measuring an amount of unroasted coffee beans;
c. grinding the unroasted coffee beans;
d. roasting the unroasted coffee beans; and
e. brewing the cup of coffee;

wherein the coffee beans are roasted according to the method of any of the above.

It is another object of the present invention to provide method for the brewing of a personalized cup of coffee as presented any of the above, wherein the parameters are selected from a group consisting of roasting parameters, grinding size, brewing temperature and brewing time/duration. It is another object of the present invention to provide method for the brewing of a personalized cup of coffee as presented any of the above, additionally comprising a step of accessing a data base.

It is another object of the present invention to provide method for the brewing of a personalized cup of coffee as presented any of the above, additionally comprising a step of loading a recipe from the data base.

It is another object of the present invention to provide method for the brewing of a personalized cup of coffee as presented any of the above, additionally comprising a step of loading coffee bean data.

It is the object of the present invention to provide a device for the brewing of a personalized cup of coffee, comprising:
a. at least one roasting unit;
b. at least one grinding unit;
c. at least one brewing unit;

wherein the roasting unit comprises at least one electromagnetic generator.

It is another object of the present invention to provide device for the brewing of a personalized cup of coffee as presented any of the above, additionally comprising a feeding unit.

It is another object of the present invention to provide device for the brewing of a personalized cup of coffee as presented any of the above, wherein the feeding unit is configured to measure a specific amount of coffee beans.

It is another object of the present invention to provide device for the brewing of a personalized cup of coffee as presented any of the above, additionally comprising a data unit.

It is another object of the present invention to provide device for the brewing of a personalized cup of coffee as presented any of the above, wherein the data unit is configured to regulate at least one of the following:
a. Roasting parameters;
b. Grinding parameters;
c. Brewing parameters.

It is another object of the present invention to provide device for the brewing of a personalized cup of coffee as presented any of the above, wherein the roasting unit comprises:
a. a resonant cavity 11;
b. a heating unit (HU) 13, comprising:
   a. at least one microwave oscillator;
   b. at least one beam-steerer;
c. a sensing unit (SU) 14; and
d. a control unit (CU) 15;

It is another object of the present invention to provide device for the brewing of a personalized cup of coffee as presented any of the above, wherein the microwave oscillator is characterized as a phase locked generator, a magnetron or as solid-state.

It is another object of the present invention to provide device for the brewing of a personalized cup of coffee as presented any of the above, wherein the power state and power output of the microwave oscillator controlled by the CU.

It is another object of the present invention to provide device for the brewing of a personalized cup of coffee as presented any of the above, wherein the beam-steerer is configured to change the standing wave appearance.

It is another object of the present invention to provide device for the brewing of a personalized cup of coffee as presented any of the above, wherein the change in the wave appearance is characterized by at least one of the following:
a. wave path;
b. wave phase;
c. wave frequency.

It is another object of the present invention to provide device for the brewing of a personalized cup of coffee as presented any of the above, wherein the beam-steerer is characterized as a deflector.

It is another object of the present invention to provide device for the brewing of a personalized cup of coffee as presented any of the above, wherein the deflector is motorized.

It is another object of the present invention to provide device for the brewing of a personalized cup of coffee as presented any of the above, wherein the deflector is controlled by the CU.

It is another object of the present invention to provide device for the brewing of a personalized cup of coffee as presented any of the above, wherein the deflector is constructed by a food grade metal.

It is another object of the present invention to provide device for the brewing of a personalized cup of coffee as presented any of the above, additionally comprising at least one antenna, connected to the microwave oscillator.

It is another object of the present invention to provide device for the brewing of a personalized cup of coffee as presented any of the above, additionally comprising at least one waveguide, interconnected to the microwave oscillator.

It is another object of the present invention to provide device for the brewing of a personalized cup of coffee as presented any of the above, wherein the sensing unit is configured to detect at least one parameter, selected from a group consisting of:
a. bean temperature;
b. radiated heat within the cavity
c. ambient temperature within the cavity;
d. Volatile Organic Compounds (VOCs) emissions;
e. bean color;
f. bean size;
g. bean shape
h. sound;
i. the amount of energy absorbed by the beans;
j. the amount of energy not absorbed by the beans; and
k. the amount of energy returned to the heat source.

It is another object of the present invention to provide device for the brewing of a personalized cup of coffee as presented any of the above, wherein the sensing unit comprises at least one detection system selected from a group consisting of thermal imaging, fiber optic based thermal sensing, image sensor, camera, spectroscopic sensor, microphone, chemical detector and a microwave receiver.

It is another object of the present invention to provide device for the brewing of a personalized cup of coffee as presented any of the above, wherein the spectroscopic sensor is selected from a group consisting of Infra-red and Ultraviolet based technologies.

It is another object of the present invention to provide device for the brewing of a personalized cup of coffee as presented any of the above, wherein the microphone is configured to detect a sound produced by the beans during roasting.

It is another object of the present invention to provide device for the brewing of a personalized cup of coffee as presented any of the above, wherein the control unit is configured to receive data from the sensing unit and regulate the heating unit.

It is another object of the present invention to provide device for the brewing of a personalized cup of coffee as presented any of the above, wherein the CU is configured to generate at least one HU order, the orders selected from a group consisting of brewing recipe, roasting recipe and roasting profile.

It is another object of the present invention to provide device for the brewing of a personalized cup of coffee as presented any of the above, wherein the CU is configured to generate at least one HU order, the order comprises at least one target point.

It is another object of the present invention to provide device for the brewing of a personalized cup of coffee as presented any of the above, wherein the target point is selected from a group consisting of bean temperature, cavity temperature, bean color, energy generated, energy absorbed, bean shape, bean sound, wave position, wave energy, wave power, antenna position, wave phase and VOC emissions.

It is another object of the present invention to provide device for the brewing of a personalized cup of coffee as presented any of the above, wherein the roasting unit comprises a container for holding the coffee beans.

It is another object of the present invention to provide device for the brewing of a personalized cup of coffee as presented any of the above, additionally comprising a container configured to hold unroasted coffee beans.

It is another object of the present invention to provide device for the brewing of a personalized cup of coffee as presented any of the above, wherein the beans are characterized as whole and un-grinded, partially grinded, completely grinded, characterized as a powder or any combination thereof.

It is another object of the present invention to provide device for the brewing of a personalized cup of coffee as presented any of the above, wherein the container is configured to conduct at least one of the following: receive the beans,
a. stir the beans;
b. mix the beans;
c. position the coffee beans;
d. remove the beans from the chamber;

It is another object of the present invention to provide device for the brewing of a personalized cup of coffee as presented any of the above, additionally comprises a system for generating a flow of air.

It is another object of the present invention to provide device for the brewing of a personalized cup of coffee as presented any of the above, wherein the air is of the temperature range of −10° C. to +200°.

It is another object of the present invention to provide device for the brewing of a personalized cup of coffee as presented any of the above, wherein the control unit is configured to:
a. receive a recipe from the data unit;
b. receive data from the sensing unit; and
c. regulate the heating unit.

It is another object of the present invention to provide device for the brewing of a personalized cup of coffee as presented any of the above, additionally comprising at least one input unit configured to receive user preferences and coffee bean information.

It is another object of the present invention to provide device for the brewing of a personalized cup of coffee as presented any of the above, wherein the input unit is characterized as a barcode reader, a touch screen, a keyboard or a mobile application.

It is another object of the present invention to provide device for the brewing of a personalized cup of coffee as presented any of the above, wherein the coffee bean information is characterized by consisting at least one of the following:
a. an item in a database;
b. coffee roasting information
c. coffee brewing data;
d. bean growing information.

It is the object of the present invention to provide a package for the storing and transporting of unroasted coffee beans, characterizes by at least one of the following:
a. comprising a filter;
b. being configured to attach to the exhaust of a coffee roasting device.

It is another object of the present invention to provide a package for the storing and transporting of unroasted coffee beans as presented in any of the above, wherein the filter technology is selected from a group consisting of high-efficiency particulate arrestance (HEPA) and activated carbon filter.

It is another object of the present invention to provide a package for the storing and transporting of unroasted coffee beans as presented in any of the above, wherein the filter is configured to remove emissions or particulate matter the exhaust of the roasting device.

It is another object of the present invention to provide a package for the storing and transporting of unroasted coffee beans as presented in any of the above, additionally comprising a barcode.

It is another object of the present invention to provide a package for the storing and transporting of unroasted coffee beans as presented in any of the above, wherein the barcode is characterized by consisting at least one of the following:
a. an item in a database;
b. coffee roasting information;
c. coffee brewing data;
d. bean growing information.

It is the object of the present invention to provide a method of loading unroasted coffee beans, comprising steps of:
a. loading coffee beans from a package into a coffee roaster or holding container of a roasting device; and
b. attaching the package to exhaust the roasting device;

wherein the package comprises a filter.

It is another object of the present invention to provide a method of loading unroasted coffee beans as presented above, wherein the filter technology is selected from a group consisting of high-efficiency particulate arrestance (HEPA) and activated carbon filter.

It is another object of the present invention to provide a method of loading unroasted coffee beans as presented above, wherein the filter is configured to remove emissions or particulate matter the exhaust of the roasting device.

It is another object of the present invention to provide a method of loading unroasted coffee beans as presented above, additionally comprising the step of loading coffee bean data.

It is another object of the present invention to provide a method of loading unroasted coffee beans as presented above, wherein the loading coffee bean data comprises a step selected from a group consisting of reading a barcode, selecting an item from a directory, accessing a mobile app and typing coffee been data.

It is another object of the present invention to provide a method of loading unroasted coffee beans as presented above, additionally comprising a step of accessing a data base and loading coffee bean data.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention wherein:

FIG. 1—present a schematic representation of the system of the present invention.

FIG. 2(a,b)—presents a schematic representation of the roasting unit of the present invention.

FIG. 3—presents the construction of a roasting unit.

FIG. 4—presents an embodiment of the roasting and brewing system of the present invention.

### DETAILED DESCRIPTION OF THE INVENTION

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide compositions and methods.

Unless otherwise stated, with reference to numerical quantities, the term “about” refers to a tolerance of ±25% of the stated nominal value.

Unless otherwise stated, all numerical ranges are inclusive of the stated limits of the range.

In the present application, the term electromagnetic (EM) heating, also referred to as microwave heating or dielectric heating, refers to process of heating an object (such as a food product) by exposing it to alternating electric field. The dielectric heater consists of:
an RF or Microwave oscillator
an RF cavity

connected so that the that a high frequency alternating electric field generated by the oscillator causes a dipole rotation withing the dielectric materials (e.g. food). The dipole rotation of the molecules within the dielectric (i.e. nonconductive) material causes energy dissipation in the form of heat. Dielectric heating is often achieved using microwaves within an enclosed metal cavity. The interference of the waves within the cavity result in a standing wave within the cavity wherein the dielectric material is placed.

In the present application, a cavity magnetron (also commonly referred to magnetron), serves as an oscillator, generating a microwave signal from a direct current electricity supplied to the vacuum tube. The magnetron comprises a high-powered vacuum tube, that generates microwaves using the interaction of a stream of electrons with a magnetic field while moving past a series of open metal cavities (cavity resonators), causing microwaves to oscillate within. The frequency of the microwaves produced (the resonant frequency), is determined by the characteristics and physical dimensions of the cavities. Magnetrons for heating food are commonly at a 2.4 Ghz or 900 hz frequency.

In the present application, Microwave Volumetric Heating (MVH) refers to a method of dielectric heating an item by using microwaves.

It is the object of the present invention, to describe a device/system for the roasting of coffee beans. The roasting unit (RU) is configured to receive the unroasted (green) coffee beans and roast the beans to the desired states. Once roasting is completed, the beans are suitable for grinding and subsequent brewing.

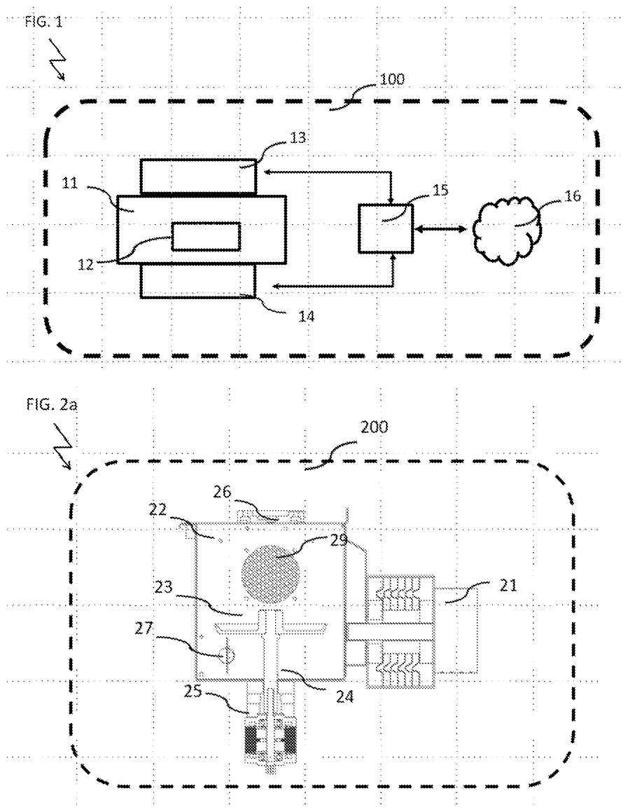

The RU 100 (FIG. 1) comprises a roasting chamber 11, encompassing a holding container 12, with a heating unit 13 and a sensing unit 14. In some embodiments, the roasting chamber is an all-metal cube-shaped box which serves as a resonant cavity. In some embodiments, the box is completely EM sealed when the system is in roasting operation.

The heating unit 13 (HU) could be at least one of the following:
Microwave emitter—either magnetron or solid-state transmitter;
RF emitter—either tube based or solid state;
IR emitter such as a Halogen lamp, QTH lamp, etc.
Induction (coil) to heat metals in the chamber which in turn radiate or conduct heat;
Conventional heating sources, such as those used in cooking ovens;

When the HU 13 is an electromagnetic emitter and heating is generated by electromagnetic waves, the heating effect can be controlled by regulating the standing wave power and pattern within the cavity.

The standing wave pattern is affected by various parameters of the system and the combination thereof:
1. The size, shape and material/construction of the cavity.
2. The physical location of the emitter with respect to the cavity.
3. The operating frequency of the emitter which determines the standing wave pattern.
4. The presence and position of a deflector (also known as a “steerer”), where its orientation changes the standing wave pattern.
5. Additional emitters, where switching on/off one (or more) individual emitters can create a superposition, changing the standing wave pattern.
6. Additional emitters/antennas, where the transmission phase is shifted to create a superposition, changing the standing wave pattern.

In one embodiment, the roasting unit 100 is microwave based and consists of the following components:
A heating unit 13, comprising:
   A microwave oscillator—that acts as the generator for microwave transmission capable of high-power output. In some embodiments, the microwave oscillator is tube-based (e.g. Magnetron) or Solid-State.
      The microwave oscillator can be controlled to power it on/off as well as control the power output.
         At least one transmitting antenna, configured to release the energy into the cavity. The antenna can be built into the microwave oscillator (like in the case of a magnetron) or separated from the oscillator.
         In some embodiments, the heating unit further comprises an interface, such as a waveguide, configured to channel the EM waves from the microwave oscillator or generator, via the transmitting antenna, into chamber. In some embodiments, the waveguide is constructed from a food-grade metal, such as aluminum or stainless steel, or is coated with a food-grade metal and is EM sealed against both the chamber and the magnetron.
         A beam-steerer that allows the system to move/regulate/control/change the standing wave appearance within the cavity, in effect to “steer” the energy concentration position. In one embodiment, the beam-steerer comprises a phase shifter and/or an antenna array. The steering can be achieved by changing the wave's path, shifting phases between several transmitting antennas and other known technologies. The beam steering is designed in a way to cover the location in space within the cavity where the beans are placed.
         The Beam-Steerer can be externally controlled to move the “beam” position.
         In some embodiment, the steerer is configured as a deflector, configured to control the EM standing waves within the chamber. The deflector can be rotated by using a motor, such as a servo (positioned outside the chamber) in an automated or semi-automated manor. The deflector is commonly constructed from metal, such as aluminum or stainless steel, or is coated with a food-grade metal. The rod is constructed from an inert polymer, such as Polyether ether ketone (PEEK) or Polytetrafluoroethylene (PTFE).
A resonant cavity 11, or chamber, where the load (i.e. coffee beans) is placed/positioned to be heated/roasted. The cavity is configured to enable the creation of a standing wave by serving as a resonant cavity and it's used for heating. In some embodiments, the roasting chamber is constructed from a food-grade metal (such as aluminum or stainless steel) or comprises a food-grade coating. In preferred embodiments of the system, the chamber is completely EM sealed when the system is closed and in roasting operation.
   In some embodiments, the chamber further comprises:
      An input door—configured to allow the (unroasted) beans to enter the chamber. When closed, the door further acts as an EM seal. In some embodiments, the door slides on the outer surface of the chamber.
      An output door—configured to enable the (roasted) beans to exit the chamber. When closed, the door further acts as an EM seal to prevent radiation from leaking out. In some embodiments, the door which slides on the outer surface of the chamber.
A sensing unit 14 (SU)—comprising a sensor or a plurality of sensors or sensing systems to track the heating and roasting process. In some embodiments, the SU is configured to track additional parameters, such as environmental conditions (humidity etc.) and bean status (color etc.).
A control unit 15 (CU)—configured to control the beam-steerer and microwave oscillator and receive that sensing and microwave data.

The container 12 (such as a cup or plate) or any other element can be used to hold the coffee beans within the chamber 11 during the roasting process. The chamber and container are constructed from food safe and heat resistant materials. In some embodiments, the cup is configured to be removed (such as for washing) and/or replaced. In some embodiments, the container is positioned on a motorized shaft/axis, so as to position and move the beans during roasting operation. In some embodiments, the plate is rotated using a stepper motor (positioned below the chamber). In some embodiments, the container is constructed from an inert polymer, such as Polyether ether ketone (PEEK) or Polytetrafluoroethylene (PTFE).

This element can also have the following functions/characteristics:
1. Position and move the beans with respect to the heat source/energy “hot spots”. This improves the control over the heating and roasting process.
2. Stir and mix the beans during roasting.
3. Separation of the beans from the chaff, by further comprises a chaff remover, located beneath the container. The chaff remover comprises a perforated surface with rotating bars on top of it. In some embodiments, the bars can be rotated to move and crush the chaff into particles small enough to fall through the perforated plate and to the chaff collector. The collector is a container, configured to hold the chaff In some embodiments, the collector acts to create a vacuum/venturi/cyclone, to draw the chaff in and remove it from the air flow.
4. The container may also be configured to:
   1. Receive and load the unroasted beans, to be inserted into the chamber. The beans could be loaded from a ‘bean hopper’.
   2. Remove the roasted beans from the chamber when roasting is complete.

The above options could be realized by physically or mechanical moving the element itself or by moving the beans within the element using stirring methods. In some embodiments, this can be achieved by non-mechanical means, such as an air flow.

The sensing unit (SU) 14 is configured to detect the roasting process. In some embodiments, the sensing unit comprises at least one sensing unit (sensor), for the tracking and analysis of the roasting process:
Temperature measurement:
   Measurement of the bean temperature, within the chamber;
      using thermal imaging.
      using fiber optic based thermal sensing.
      Using EM isolated temperature sensor (such as thermistor, thermocouple and such)
      The temperature of the beans is typically in the range of 20-250° C.
   Measurement of radiated heat (ambient temperature) in given locations within the cavity using:
      thermocouple/thermistor sensor.
      using thermal imaging.
      using fiber optic based thermal sensing.
         The temperature in the chamber/cavity is typically in the range of 20-300° C.
Monitoring environmental conditions, such as humidity.
Monitoring of Volatile Organic Compounds (VOCs) emitted during roasting.
Monitoring and/or detecting the changes in bean color by means of an:
   Image sensor (camera);
   Spectroscopic sensor (such as Infra-red, Ultraviolet etc.). In some embodiments, the spectroscopic reading can be used to identify and detect chemical compositions and changes in the coffee beans.
Monitoring the sound produced by the beans when being roasted and more specifically the typical cracking sound (often referred to as “first crack” and “second crack” in the industry)
Measuring the amount of energy absorbed by the beans. in some embodiments, this is conducted by measuring the energy that is not absorbed and is returned to the heat source. In some embodiments, the returned energy is recorded by the microwave receiver. In some embodiments, the system is configured to measuring the dielectric properties of the heated beans to determine their chemical composition and temperature by analysis of the returned microwave (or RF) signal.

In some embodiments, the roasting process, is controlled by a control unit (CU) 15 that is interconnected to the heating unit (HU) 13 and the sensing unit (SU) 14. The CU is configured to:
1. Access and load a roasting profile (“recipe for the roasting of coffee beans”). The recipe can be stored in a data base that is onsite (as part of the CU) or in another unit, such as a cloud-based server 16. In some embodiments, the recipe is provided by the user when activating the system;
2. Monitor the roasting progress, using data from at least one sensor.
3. Receive data from the SU.
4. Control the HU, used to heat the beans. The control is based on the data received from the SU, recipe and on the data from the data unit.
5. Optionally: Repeat(s) the process until the desired roast is reached—the target could be determined based on any of the measurements (such as the bean temperature, bean color or any other property measured by the sensor).

In some embodiments, the recipe comprising a series of orders, each order based on at least one ‘end/target points’:
Target bean temperature;
Target chamber temperature;
Target bean color;
Target sound (also known as ‘first crack’);
A duration of temperature change (Heating and/or cooling);
A duration of constant temperature;
Target energy output;
Target energy absorbed by the beans.

In some embodiments, the SU communicates the status of the roasting process and system to the CU and the reaching of the designated end/target point.

In some embodiments, the CU is connected to a network and is configured to access a cloud-based database.

The CU is operated by software that controls the roasting process. The software (SW) regulates that heating process, controls the Microwave Oscillator and the Beam-Steerer, and receives signals from the Microwave Receiver as well as the Sensing unit.

The SW incorporates algorithms to properly control the microwave “beam” to regulate the degree of homogeneity of bean roasting. It also holds information about various roasting profiles to achieve desired roast level. In some embodiments, the SW enables differential roasting or roasting profile for each individual bean.

In some embodiments, the CU generates a series of orders comprising at least one ‘end/target point’. In one embodiment, the SU generates data regarding the status of the roasting and the reaching of the end/target point. The status/data is transferred to the CU.

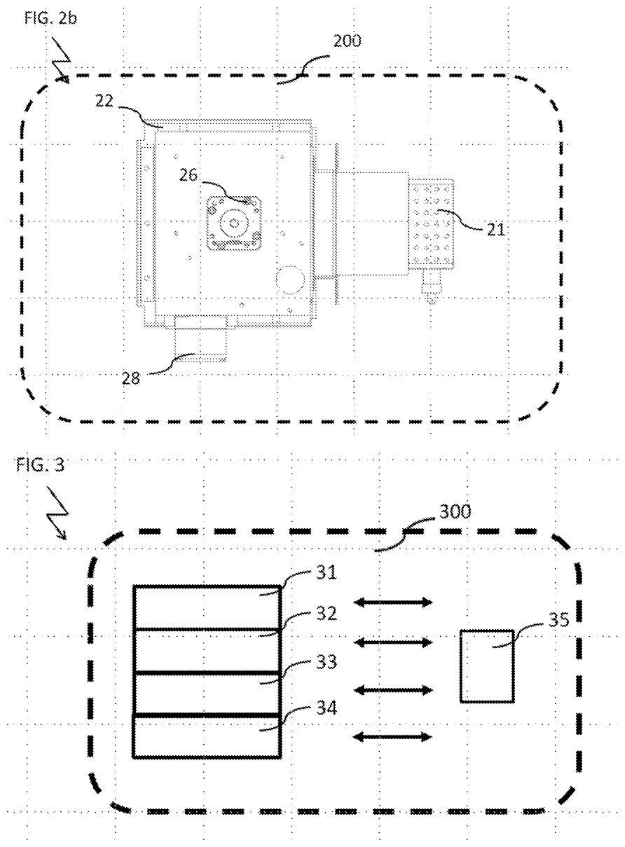

Reference is made to FIG. 2(a,b), presenting a side (FIG. 2a) and top (FIG. 2b) view of an embodiment of the RU 200, comprising a magnetron 21 that feeds to the roasting chamber 22. The roasting plate 23 holds the coffee beans during roasting and is rotated during the roasting process by shaft 24, connected to a motor 25. The deflector 27 is rotated by a servo motor 28. A sensor (Camera) 26 is attached to the chamber 22, to track and control the roasting process. A vent 29 enables release of any VOC generated during roasting.

The roasting process is known to produce various waste products and emissions. These can be solid particular matter (PM), such as small particles of bean or other matter released during roasting, or gaseous, such as volatile organic compounds (VOC) and organic acids. In some embodiments the system comprises a system for the removal of the hazards components/contaminants from the exhaust by a filter, such as a high-efficiency particulate arrestance (HEPA), activated carbon/charcoal filter or other known filter technologies.

It is another object of the present invention to describe a device/system for the preparation of a cup of coffee, comprising the roasting unit 100 of FIG. 1 The device is configured to be placed at home or in a place of business.

The roasting system of the present invention 300 comprises a number of components (FIG. 3):
1. At least one holding and/or feeding unit 31;
2. a roasting unit 32;
3. a grinding unit 33;
4. a brewing unit 34; and
5. a data unit 35.

The holding and feeding unit 31 is configured to hold and present a measured amount of unroasted coffee beans to the roasting unit. In some embodiments, the system comprises more than one holding unit, enabling the holding more than one variety of beans. The holding unit is constructed from a food-safe material, generally recognized as safe (GRAS), such as stainless steel and plastic based material. In some embodiments, the material is listed by the European Union (as regulated in EC No. 1935/2004) and the FDA.

The roasting unit feeds to a storage/holding unit or to a grinding unit 33, that can be based on any conventional and known grinding/milling technologies. The grinding unit can utilize known dry milling technologies, such as burr-grinding or chopping. The grinding parameters, in particular particle size, are selected by the user or are generated as part of a (personalized) recipe.

The grinding unit feeds to a brewing unit 34. The brewing unit can be based on any conventional and known brewing technologies in some embodiments, the brewing unit comprises a hot and/or cold-water generator(s) and a brewing unit. The brewing can be characterized by a variety of parameters:
1. Coffee-to-water ratio: specifically the amount of water added to a specific amount of coffee. The ration is commonly referred to by a gram-to-gram ration (such as 1:8), as coffee-to-water.
2. Water temperature: the water can be at a temperature of cold water (cold brew), up to boiling water (100° C.). The water can be provided at more than one temperature (such as adding cold water to a brewed cup of coffee).
3. Brewing method: the brewing could be conducted by infusion (such as seeping (such as French press), or boiling (such as Turkish coffee).
4. Brewing duration: the time the coffee grounds are in contact the water (are immersed in the water).
5. Brewing pressure: The brewing could be conducted at a pressure range from atmospheric pressure up to 18 Barr (100 kPa, 14.5 psi), forcing the water through the coffee grinds.

In some embodiments the brewing unit compresses a unit (milk unit MU) configured to add at least one dairy product or non-dairy alternative to the cup of coffee. The dairy product could be milk or cream based. The non-dairy alternative could be based on varies know vegetable-based sources, such as legumes (such as soy, pea), seeds (such as hemp and flax seed), grains (such as oats and rice) and nuts (such as almonds and hazelnuts). The milk (on non-dairy alternative) product could be cold milk (on non-dairy alternative) or the milk could undergo a treatment, such as heating and blending or whipping. The product could be frothed milk, hot/heated/warmed milk, milk froth or a mixture thereof In some embodiments, the MU is configured to store the milk unprocessed milk (or non-dairy alternative), such as being constructed from a food safe material and having a temperature-controlled environment.

The system comprises a Data Unit (DU) 35 that comprises the brewing parameters, comprising:
1. Recipes: comprising coffee preparation parameters:
   i. Roasting: such as temperature, duration, rate of change and end point;
   ii. Grinding: such as particle size.
   iii. Brewing conditions/parameters: such as water temperature, water/coffee ration, seeping duration, brewing pressure, filter type;
   iv. Additions, such as milk, flavorings etc.
2. Bean parameters and characteristics, such as:
   i. Beans variety(s);
   ii. Bean's growth conditions:
      a. Climatic conditions (weather), such as rain and temperature;
      b. Geographic and geological conditions, such as soil type and altitude;
      c. Harvest conditions;
      d. Post-harvest processes, such as drying and fermentation;
   iii. Storage duration and conditions;
   iv. Additional bean characteristics can also include Chemical analysis of the beans;
3. User data:
   i. User preferences;
   ii. User feedback and review;

In some embodiments, the Data Unit 35 is a cloud-based data base (CBDB) or is connected to a CBDB 16. In some embodiments, the CBDB can be accessed by a user via a remote device, such as a webpage or a mobile application. The user can access the CBDB to create recipes, update existing recipes or upload data regarding the contents of a specific batch.

In some embodiments, the system additionally comprises a display and/or input device, enabling the user to create, edit or select the wanted, personalized recipe. In some embodiments, the input devise enables the user to enter feedback to the brewed coffee. In some embodiments, the input device additionally comprises a barcode reader, loading the bean parameters of the batched added to the holding unit. The barcode could be printed on a bean package.

In some embodiments, the unroasted coffee beans are delivered in a container or package (such as a bag, container or cartridge). The package label contains information regarding the parameters of the beans. In some embodiments, the label contains a barcode, linked to the beans data. The package is constructed from food safe materials. In some embodiments, the materials are characterized as stopping the transfer of air or moisture. In some embodiments, an air filter is constructed as part of the package and the package or the filter is configured to be attached to the exhaust of the roasting unit and remove the containments from the exhaust. In some embodiments, the filter is characterized as a high-efficiency particulate arrestance (HEPA), activated carbon/charcoal filter or other known filter technologies.

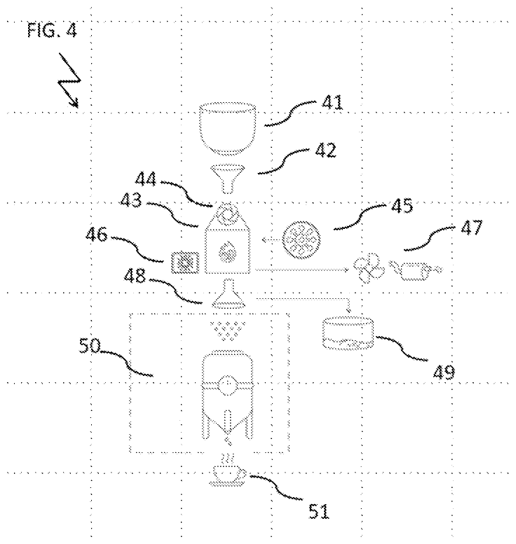

Reference is made to FIG. 4, showing an embodiment of the roasting and brewing system of the present invention. A holder/hopper 41 hold the unroasted coffee beans, funneled 42 into a roasting chamber 43, comprising a sensor 44 for controlling the process and heated by a magnetron 45. The electronics is housed on the chamber 46. The chamber is cooled by a fan 47. A lower funnel 48 feeds the roasted beans to a ‘bean-to-cup’, brewing machine 50, producing a cup of coffee 51, with the waste removed 49.

### EXAMPLES

### Example # 1

### A Roasting System

1. A resonant cavity
2. A cup positioned in the chamber holds the beans and rotates to change the beans' position, relative to the wave pattern.
3. a 2.4 Ghz magnetron, transmitting through a waveguide entering the cavity from the side. The waveguide pattern is controlled by rotating a “steerer” located on the opposite side from the magnetron and which is rotated with an electrical motor. The magnetron power is controlled to output variating power between 300-1000 Watt.
4. A thermal camera placed above the “cup” to monitor the heating of the chamber and the roasting of the beans.
5. Removing the chaff by regulating the rotation speed (generating the necessary centrifugal force) and air flow.
6. Removing the roasted beans by higher rotation speed.

The system is controlled by a combination of a naive algorithm, which handles the rapid heating to a specific temperature point, combined with a neural-network model, which controls the process from that point, is used for obtaining heating and roasting homogeneity and maintaining it until the beans have reached to desired roasting point/result.

### Example # 2

### Recipe: An Example of a Recipe for the Brewing of a Single Espresso Shot

Unroasted coffee beans: 7G grams.
Roasting:
   Heat to 180° c for 1 min;
   Maintain at 180° c for 1 min;
   Heat to 210° c over 3 min;
   Cool-down over 1 min.
Grinded to a 350-400-micron average particle size
Brewed with 14-gram water (2-to-1 ratio) at 88° C. and 9 Bar pressure for a period of 25 sec.
Filtered through 7-gram single basket.

1.-90. (canceled)

91. A coffee roaster 100, comprising:
a. a resonant cavity 11;
b. a heating unit (HU) 13, comprising:
i. at least one microwave oscillator;
ii. at least one beam-steerer;
c. a sensing unit (SU) 14; and
d. a control unit (CU) 15;
wherein said control unit is configured to control said microwave oscillator and said bean-steerer in order to regulate the spatial position of said wave, according to data received from said sensing unit.

92. The roaster of claim 91, additionality characterized according to at least one of the following:
a. said microwave oscillator is characterized as a phase locked generator, a magnetron or as solid-state.
b. the power state and power output of said microwave oscillator controlled by said CU.
c. said beam-steerer is configured to change the standing wave appearance.

93. The roaster of claim 92, wherein said change in said wave appearance is characterized by at least one of the following:
a. wave path;
b. wave phase;
c. wave frequency.

94. The roaster of claim 91, wherein said beam-steerer is characterized as a deflector.

95. The roaster of claim 94, wherein said deflector is characterized by at least one of the following:
a. said deflector is motorized;
b. said deflector is controlled by said CU;
c. said deflector is constructed by a food grade metal.

96. The roaster of claim 91, additionally comprising at least of the following:
a. an antenna, connected to said microwave oscillator;
b. a waveguide, connected to said microwave oscillator.

97. The roaster of claim 91, wherein said sensing unit is characterized according to at least one of the following:
a. configured to detect at least one parameter, selected from a group consisting of:
i. bean temperature;
ii. radiated heat within the cavity;
iii. ambient temperature within the cavity;
iv. Volatile Organic Compounds (VOCs) emissions;
v. bean color;
vi. bean size;
vii. bean shape;
viii. sound;
ix. the amount of energy absorbed by the beans;
x. the amount of energy not absorbed by said beans; and
xi. the amount of energy returned to the heat source.
b. comprises at least one detection system selected from a group consisting of thermal imaging, fiber optic based thermal sensing, image sensor, camera, spectroscopic sensor, microphone, chemical detector and microwave receiver.

98. The roaster of claim 97, wherein said s sensing unit is characterized by at least one of the following:
a. said spectroscopic sensor is selected from a group consisting of Infra-red and Ultraviolet based technologies;
b. said microphone is configured to detect a sound produced by said beans during roasting.

99. The roaster of claim 91, wherein said control unit is configured according to at least one of the following:
a. to receive data from said sensing unit and regulate said heating unit;
b. to generate at least one HU order, said orders selected from a group consisting of brewing recipes and roasting profiles;
c. to generate at least one HU order, said order comprises at least one target point.

100. The roaster of claim 99, wherein said target point is selected from a group consisting of bean temperature, cavity temperature, bean color, energy generated, energy absorbed, bean shape, bean sound, wave position, wave energy, wave power, antenna position, wave phase and VOC emissions.

101. The roaster of claim 91, additionally comprises a system for generating a flow of air.

102. The roaster of claim 101, wherein said air is of the temperature range of −10° C. to +300° C.

103. The roaster of claim 91, wherein said system is configured to:
a. be attached to an existing or external system, grinder, coffee brewer or container;
b. feed roasted beans to an external system, grinder, coffee brewer or container.

104. A method for the roasting of coffee beans, comprising steps of:
a. Obtaining the roaster of claim 91;
b. placing unroasted coffee beans in a chamber;
c. generating a roasting recipe;
d. generating an electromagnetic wave, said wave heating said beans in said chamber; and
e. measuring roasting parameters, said parameters selected from bean parameters and chamber parameters;
wherein said beans are characterized as whole and un-grinded, partially grinded, completely grinded, characterized as a powder or any combination thereof

105. The method of claim 104, additionally comprising a step of changing said electromagnetic wave appearance.

106. The method of claim 105, wherein said electromagnetic wave appearance is controlled by regulating at least one of the following:
a. power state of microwave generator;
b. power output of microwave generator;
c. wave path of microwave oscillator;
d. phase shift of microwave oscillator;
e. antenna array of microwave oscillator;

107. The method of claim 105, wherein said electromagnetic wave appearance is characterized by at least one of the following:
a. homogenous radiating of said target beans;
b. homogenous radiating of said cavity;
c. rapid radiating of said target beans;
d. high energy efficiency.

108. The method of claim 104, wherein said step of measuring roasting parameters comprises a parameter selected from a group consisting of bean temperature, radiated heat within said cavity, ambient temperature within said cavity, Volatile Organic Compounds (VOCs) emissions, bean color, sound generated by said beans, energy absorbed by the beans, energy not absorbed by said beans, and energy returned to the heat source.

109. The method of claim 104, additionally comprising at least one step, selected from a group consisting of:
a. generating at least one heating order;
b. loading coffee bean data;
c. grinding said unroasted coffee beans.

110. The method of claim 109, wherein said step of generating at least one heating order characterized by at least one of the following:
a. said heating order is generated by a control unit;
b. said control unit is configured to conduct at least one of the following:
i. receive and read said measured parameters;
ii. control said electromagnetic wave appearance;
c. said heating order is selected from a group consisting of bean temperature, cavity temperature, bean color, energy generated, energy absorbed bean sound, wave position, wave energy, wave power, antenna position, wave phase and VOC emissions.
